(19) United States
(12) Patent Application Publication
(10) Pub. No.: US 2012/0281178 A1
(43) Pub. Date: Nov. 8, 2012

(54) DECORATION FOR EYEGLASSES

(76) Inventor: Maureen FREDER, Greenwich, CT (US)

(21) Appl. No.: 13/461,375

(22) Filed: May 1, 2012

Related U.S. Application Data
(60) Provisional application No. 61/481,686, filed on May 2, 2011.

(51) Int. Cl. G02C 11/02

(52) U.S. Cl. 351/52; 351/51

(57) ABSTRACT

The disclosure provides a decoration or ornament for the earpiece of eyeglasses. This decoration or ornament is typically in the form of a charm in a design which is intended to be appealing to young people.

### FIELD OF THE DISCLOSURE

The disclosed embodiments relate to decorations or ornaments for eyeglasses. In particular, the disclosed embodiments include, but are not limited to, charm-type decorations which slide onto the earpiece of eyeglasses.

### BACKGROUND OF THE DISCLOSURE

Many people are uncomfortable wearing eyeglasses. In particular, many fashion conscious people, of all ages, may believe that eyeglasses do not offer an opportunity to make a fashion statement, at least not at a reasonable cost. In particular, it may be difficult to convince young people that they can wear eyeglasses while making a personal fashion statement. There also remains a need in the industry for young children to be more accepting to wear glasses.

### SUMMARY AND OBJECTS OF THE DISCLOSURE

It is therefore an object of the present disclosure to allow a person, particularly, but not limited to, a young person, to make a fashion statement with eyeglasses. Young children will be more accepting to wearing glasses when they can personalize the glasses with the present invention.

It is therefore a further object of the present disclosure to achieve the above object at a very reasonable cost.

### BRIEF DESCRIPTION OF THE DRAWINGS

In the drawings, wherein similar reference characters denote similar elements throughout the several views:

FIG. 1 is a front plane view of a first embodiment of the present disclosure.

FIG. 2 is a front plane view of a second embodiment of the present disclosure.

FIG. 3 is a perspective view of a pair of eyeglasses with the first embodiment of the present disclosure attached thereto.

FIG. 4 is a perspective view of a pair of eyeglasses with the second embodiment of the present disclosure attached thereto.

FIG. 5 is a plane view of the top portion of the first embodiment of the present disclosure.

FIG. 6 is a plane view of the bottom portion of the first embodiment.

FIG. 7 is a plane view of an alternative first embodiment.

### DETAILED DESCRIPTION

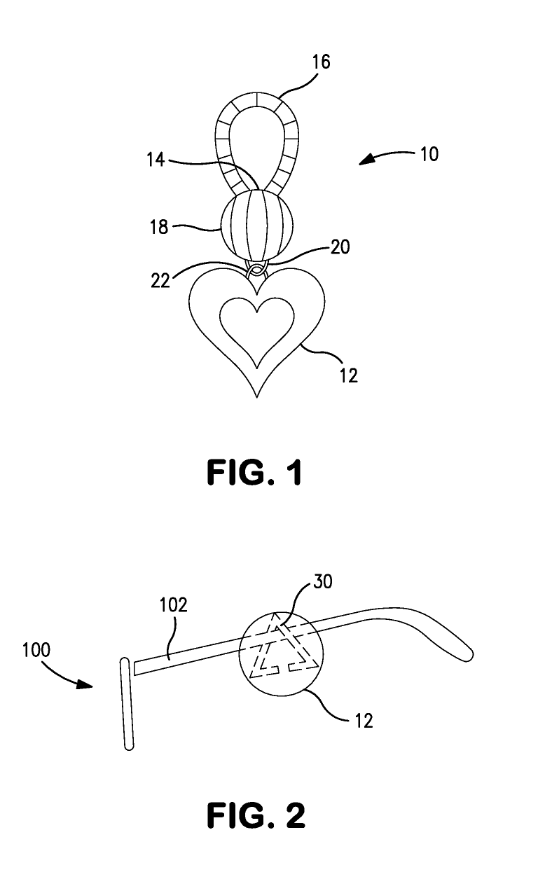

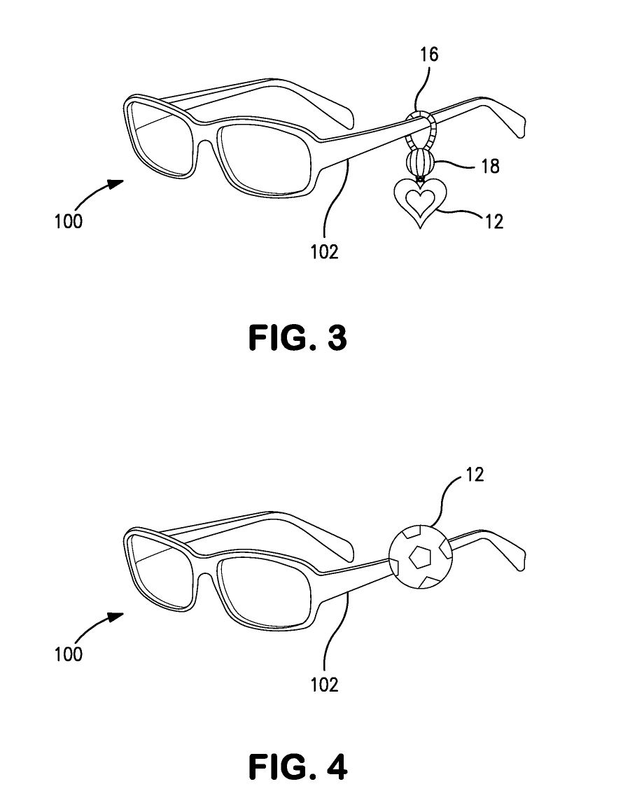

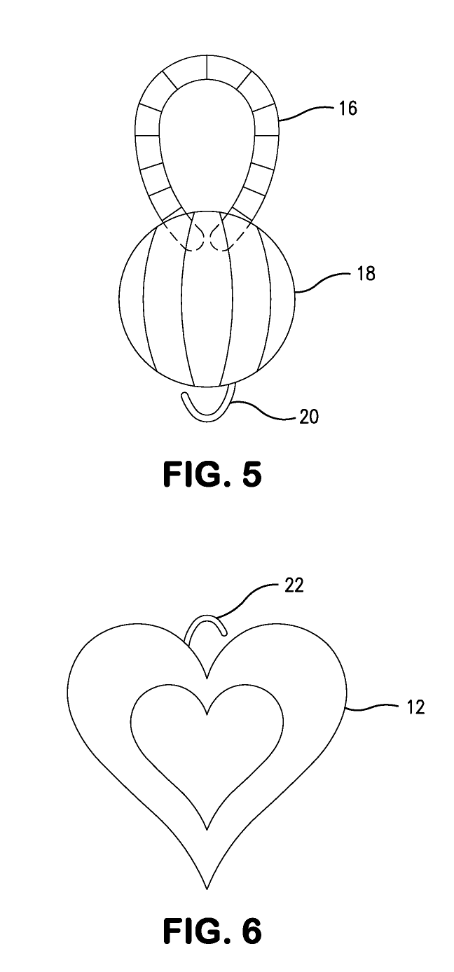

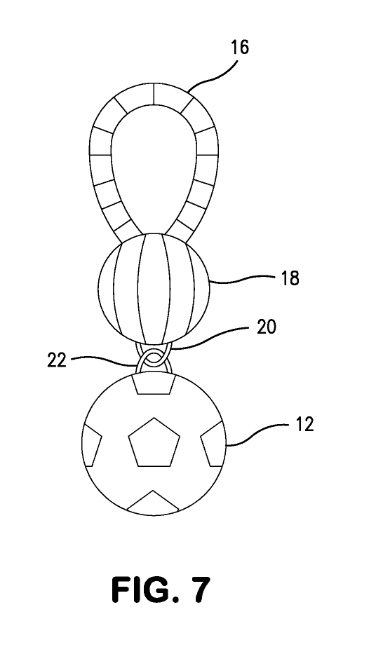

Referring now to the drawings in detail, wherein like numerals refer to like elements throughout the several views, one sees that FIG. 1 is a plan view of a first embodiment of the eyeglass decoration 10 of the present disclosure. The eyeglass decoration 10 includes a heart-shaped charm 12 (or decorative portion) which includes a ring 14 for suspension from an elastic band 16. The heart-shaped charm 12, which may be of a silver plated enameled material, is shown in more detail in FIG. 6 while the elastic band 16 is shown in more detail in FIG. 5. Of course, this disclosure envisions the use of any number of designs of the charm 12. For example, charm 12 may include, but is not limited to: a peace sign (multiple colors), heart (multiple colors), star (multiple colors), princess crown, ice cream cone; sun & moon; musical note; ballet slippers; gymnast; silver floating heart; any combination thereof; and the like. Multiple colors includes any color or color combination. The elastic band 16 is formed in a loop which is held in place by ball 18. Ball 18 is typically metallic or silver-plated and lead safe and includes a lower ring 20 for attachment to upper ring 22 of charm 12. As shown in FIG. 3, the elastic band 16 is slipped around the earpiece 102 of a pair of eyeglasses 100, so that the charm 12 is suspended therefrom in a decorative manner.

FIG. 2 shows a second embodiment wherein a triangular-shaped finding 30 is provided for attachment to the earpiece 102 of a pair of eyeglasses 100. The charm 12 (shown in FIG. 2 as a soccer ball, but is not limited thereto, with iconic sports equipment, including balls, expected to be especially popular) is soldered to the finding 30 so that the charm 12 has a substantially flush appearance with the earpiece 102 of a pair of eyeglasses, as shown in FIG. 4. As with the first embodiment of FIG. 1, the charm 12 may be of a silver-plated enameled material.

Other alternative embodiments or implementations according to the various teachings of the present disclosure will be understood by those skilled in the art and are achieved without departing from the spirit and scope of the disclosure. It is therefore intended that the present disclosure is not limited to the disclosed embodiments described herein but should be defined in accordance with the claims that follow.

1. A decoration for eyeglasses, comprising:
a support portion for engaging the eyeglasses; and
a decorative portion attached to the support portion and suspended therefrom.

2. The decoration of claim 1, wherein said support portion includes a loop portion.

3. The decoration of claim 2 wherein said loop portion is secured by a metallic portion.

4. The decoration of claim 3 wherein the loop portion is elastic.

5. The decoration of claim 4 wherein said metallic portion is silver-plated.

6. The decoration of claim 5 wherein said support portion includes a first ring and said decorative portion includes a second ring, and wherein said first ring engages the second ring.

7. The decoration of claim 6 wherein the decorative portion is silver-plated.

8. The decoration of claim 7 wherein the decorative portion is enameled.

9. The decoration of claim 7 wherein the decorative portion is chosen from multiple colors and includes at least one of the following: a heart-shaped; a peace sign; a star; a princess crown; an ice cream cone; sun & moon; a musical note; a ballet slippers; gymnast; a silver floating heart; and any combination thereof.

10. The decoration of claim 7 wherein the decorative portion is a charm.

11. A decoration for eyeglasses, comprising:
a support for engaging the eyeglasses; and
a decorative portion attached to the support portion so as to have a substantially flush appearance.

12. The decoration of claim 11 wherein the support portion is a finding.

13. The decoration of claim 12 wherein the finding attaches to an earpiece of a pair of eyeglasses.

14. The decoration of claim 13 wherein the decorative portion is soldered to the finding.

15. The decoration of claim 13 wherein the decorative portion is silver-plated.

16. The decoration of claim 13 wherein the decorative portion is enameled.

17. The decoration of claim 13 wherein the decorative portion has an appearance of a piece of sports equipment.

18. The decoration of claim 13 wherein the decorative portion has an appearance of a ball used in sports.

19. The decoration of claim 13 wherein the decorative portion has an appearance of a soccer ball.

20. The decoration of claim 12 wherein the finding is triangular shaped.
